(19) United States
(12) Patent Application Publication
(10) Pub. No.: US 2026/0077513 A1
(43) Pub. Date: Mar. 19, 2026

(54) ROBOTIC ARM

(71) Applicant: ABB SCHWEIZ AG, Baden (CH)

(72) Inventors: Kaiyuan Cao, Shanghai (CN); Jiafan Zhang, Shanghai (CN)

(21) Appl. No.: 19/398,904

(22) Filed: Nov. 24, 2025

Related U.S. Application Data
(63) Continuation of application No. PCT/CN2023/096279, filed on May 25, 2023.

(51) Int. Cl. B25J 18/00; B25J 19/00

(52) U.S. Cl. CPC B25J 18/002; B25J 19/007

(57) ABSTRACT

A robotic arm body includes a structural part including a body portion made of plastic material and including an inner chamber; at least one mounting interface provided on the body portion and configured to be connected to a second component of a robot; an opening provided in the body portion and communicating with the inner chamber; and a reinforcement part fixed to the body portion at the opening.

### FIELD

Embodiments of the present disclosure generally relate to an industrial robot, and more specifically, to a robotic arm made of plastic material.

### BACKGROUND

Industrial robots are widely used in various industry fields. An industrial robot typically comprises a robotic arm formed by a plurality of axial joints, each joint including a casing and an actuator arranged therein, and a plurality of structural arms connecting the adjacent joints. An end effector may be fixed to an end flange of the robotic arm and are designed to perform various tasks. The casing of the joint and the structural arms are load bearing members and are designed with sufficient strength to withstand loads. Typically, these structural members are made of lightweight metals, such as aluminum alloys, to ensure sufficient structural strength.

There is an increasing trend of using plastic material to replace the metal to construct these structural members. This may bring about a number of advantages. Since load bearing structural members of the robotic arm are made of plastic material, they can be manufactured via injection molding, which significantly reduces the manufacturing costs of the industrial robot, obviates need to painting their outer surfaces while it can ensure its lightweight.

### SUMMARY

Example embodiments of the present disclosure provide a robotic arm body mainly made of plastic material and an industrial robot with improved structural strength.

In a first aspect of the present disclosure, there is provided a robotic arm body. The robotic arm body comprises a structural part comprising a body portion made of plastic material and comprising an inner chamber; at least one mounting interface provided on the body portion and configured to be connected to a second component of a robot; an opening provided in the body portion and communicating with the inner chamber; and a reinforcement part fixed to the body portion at the opening. With this arrangement, strength of the robotic arm body can be strengthened by the reinforcement part at the opening.

In some embodiments, the reinforcement part may be shaped to match the opening to close the opening. With this arrangement, the strength of the robotic arm body can be further strengthened.

In some embodiments, the reinforcement part may be fixed to the body portion via at least one of the following: screw connection, thermal fusing, snap-fitting, and adhesive.

In some embodiments, the body portion may comprise a flange protruding toward the inner chamber around the opening or a plurality of connecting posts distributed around the opening within the inner chamber; the reinforcement part comprises a plurality of mounting holes for screw connection; and the reinforcement part is fixed to the annular flange or the connecting posts by a plurality of screw fasteners.

In some embodiments, the annular flange or the connecting post may comprise a metal connection portion, or a plastic connection portion in which a metal insert is provided.

In some embodiments, the structural part may be a one-piece part which is integrally formed via injection molding.

In some embodiments, the reinforcement part may be made of the same material as the structural part, or of a second material having rigidity greater than the structural part.

In some embodiments, the reinforcement part may be a metal plate.

In some embodiments, the reinforcement part may comprise a manhole at a position corresponding to the mounting interface.

In some embodiments, the robotic arm body may further comprise a cover above the reinforcement part and configured to close the opening.

In some embodiments, the reinforcement part may comprise at least one reinforcement part provided within the inner chamber adjacent to the at least one mounting interface.

In some embodiments, the reinforcement part may comprise a first reinforcement part shaped to match a size of the opening to close the opening; and at least one second reinforcement part arranged between the first reinforcement part and the body portion, the second reinforcement part provided within the inner chamber adjacent to the at least one mounting interface.

In some embodiments, at least one of the first reinforcement part and the second reinforcement part may be fixed to the body portion via at least one of the following: screw connection, thermal fusing, snap-fitting, and adhesive.

In some embodiments, the body portion may be an elongate arm form and may comprise an elongate body comprising a first lengthwise side and a second lengthwise side opposite to the first lengthwise side; and two opposite end portions located a respective end of the an elongate body, each of the end portions comprising a tubular body; and wherein the mounting interface is provided on the tubular body at the first lengthwise side and the opening is provided at the second lengthwise side.

In some embodiments, the body portion may be in a pipe form curved in an L-shape and comprising two opposite end portions, the mounting interface may be provided at one of the end portion, and the opening is provided at a bent portion of the pipe.

In a second aspect of the present disclosure, there is provided an industrial robot. The industrial robot comprises a base, and a robotic arm body according to the first aspect.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is an overall view of an industrial robot according to one example embodiment of the present disclosure;

FIG. 2 is a perspective view of a robotic arm body according to one example embodiment of the present disclosure as viewed from a back side;

FIG. 3 is an exploded view of the robotic arm body in FIG. 2;

FIG. 4 is a perspective view of a robotic arm body according to one example embodiment of the present disclosure as viewed from a front side;

FIG. 5 is a perspective view of a robotic arm body according to a second example embodiment of the present disclosure without a cover;

FIG. 6 is an exploded view of a robotic arm body according to a third example embodiment of the present disclosure;

FIG. 7 is a perspective view of the robotic arm body in FIG. 6, with the body portion and the reinforcement part being assembled together;

FIG. 8 is a an exploded view of a robotic arm body according to a fourth example embodiment of the present disclosure;

FIG. 9 is a perspective view of the robotic arm body in FIG. 8, with the body portion and the reinforcement part being assembled together;

FIG. 10 is a perspective view of a robotic arm body according to a fifth example embodiment of the present disclosure; and

FIG. 11 is an exploded view of the robotic arm body in FIG. 10.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to. ” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

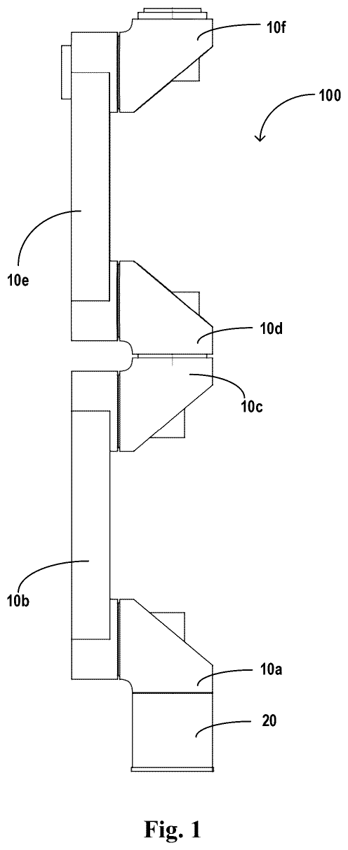

FIG. 1 is an overall view of an industrial robot 100 according to one example embodiment of the present disclosure. As shown in FIG. 1, the industrial robot 100 comprises a base 20, a plurality of joints (its casing or arm body being shown and labeled as 10a, 10c, 10d, 10e), and a plurality of connecting arms (labeled as 10b, 10e in the shown example) connecting two adjacent joints. Each joint may include a casing. One or more actuators are provided within the casing. The actuator, for example, may include a motor, a reduction gear, and the like, as well known in the art. A controller may be provided in the base 20. The actuators within the casing can be controlled by the controller so as to control a posture of the robotic arm and/or a movement path of an end effector provided at the distal end of the robotic arm.

The casings 10a, 10c, 10d, 10e of the joint and the connecting arms 10b, 10e are load bearing members and are designed with sufficient strength so as to bear loads. According to the present disclosure, the casings 10a, 10c, 10d, 10e of the joint and the connecting arms 10b, 10e are collectively called as a robotic arm body. As mentioned above, due to the fact that the plastic member can be manufactured, for example, by injection molding, which means lower manufacturing costs and many complex steps that are needed in processing conventional metal members can be omitted, there thus is technical trend that using plastic material to manufacture the robotic arm bodies.

However, when the robotic arm bodies are made of plastic material, a number of problems should be solved. One problem is that connection strength between two plastic components is insufficient after long operation period. These robotic arm bodies should be connected as a whole to constitute the robot. Thus, a mounting interface of the arm body should ensure that the robot can be assembled with ease. Moreover, when one plastic component is fixed to another component of constituting the robot, there is a high risk that connection between the components becomes loose or connection strength between the components becomes insufficient when the robot operates over time. That is because plastic material has a creep risk when the plastic components of the robot operate under stress over a long time. Thus, the mounting interface of the arm body should be of sufficient connection strength to ensure the connection strength at the mounting interface. Another problem is that the arm body itself is subject to breakage during service time of the robot. That is because the strength and mechanical performances of the plastic arm body is significantly different from metal. Sometimes, the plastic arm body may also comprise openings which further reduce the structural strength of the arm body. Thus, there is a need to strengthen the plastic arm body. According to the present disclosure, a novel robotic arm body is proposed to solve one or more the abovementioned problems.

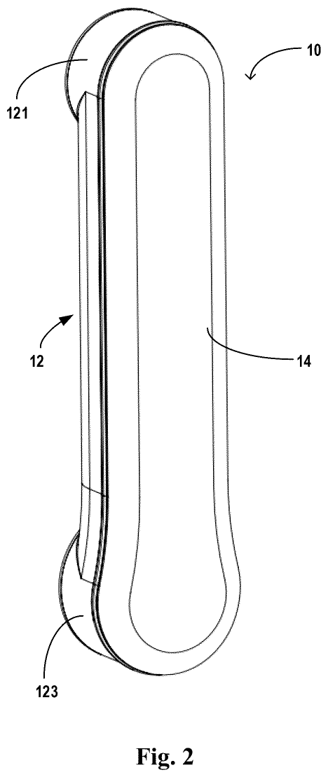

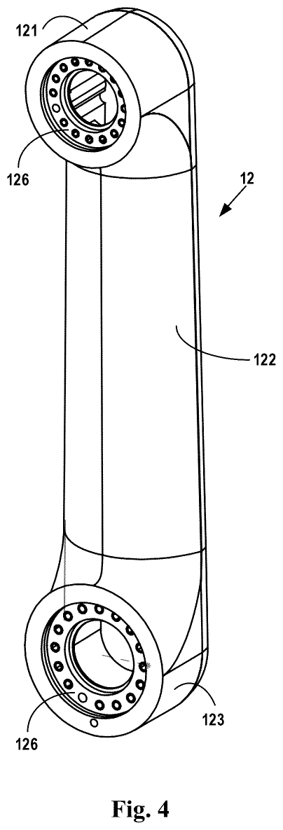

FIGS. 2-4 show a robotic arm body 10 according to one example embodiment of the present disclosure. As shown in FIGS. 2-4, the robotic arm body 10 includes a structural part 12, a reinforcement part 16 fixed to the structural part 12, and a cover 14 above the reinforcement part 16.

The structural part 12 includes a body portion 122 mad of plastic material. The structural part 12 may be formed by injection molding. The structural part 12 thus may be a one-piece part which is integrally formed via injection molding. The body portion 122 defines an inner chamber. Within the inner chamber of the body portion 122, electrical components, such as cables for powering or communication, and actuators, may be arranged.

The structural part 12 may be formed as various shapes. In the shown example, the structural part 12 is of elongate arm shape. The structural part 12 may include a first lengthwise side (i.e., a front side or a connection side at which the structural part 12 is connected to another component) and a second lengthwise side opposite to the first lengthwise side (i.e., a back side). The body portion 122 is shown as an elongate body and provided at the front side. The structural part 12 may also include an opening 124 provided in the body portion 122 at a back side and communicates with the inner chamber. Via the opening 124, an inner side of the structural part 12 can be easily accessed. This is advantageous in assembling the robot. The opening 124 may also provide additional advantages in manufacturing the structural part 12. Via the opening 124, a draft angle for molding the structural part 12 can be ensured such that the structural part 12 can be molded with ease. In the shown example, the whole back side of the structural part 12 is open and is labelled as the opening 124. This facilitates drafting of the mold and simplifies the structure of the mold for molding the structural part 12. In the shown example, the structural part 12 is of an elongate arm shape and the opening 124 is provided as an elongate hole. It is to be understood the shown example is merely illustrative and the structural part 12 and the opening 124 may be of any other proper shapes and/or forms.

One or more mounting interfaces 126 may be arranged on the body portion 122. The robotic arm body 10 may be connected to a second component of the robot (for example another robotic arm body) via the mounting interface 126. In the shown example, two mounting interfaces 126 are provided at two opposite end portions 121, 122 of the body portion 122 which are located a respective end of the elongate body. Each of the end portions 121, 122 comprising a tubular body defining an amounting opening. The mounting interface 126 is provided on the tubular body.

The mounting interface 126 may be of various forms. In the shown example embodiment, the mounting interface 126 is provided at the mounting opening of the tubular body and includes a flange portion. The flange portion may extend radially inward from an inner wall surface of the tubular body to partially block the mounting opening. A plurality of holes 127 may extend axially and is circumferentially distributed around the mounting opening. Other components constituting the robotic, such as another robotic arm or the actuator, may be fixed to the structural part 12 via the flange portion. For example, a plurality of screw fasteners can axially connect the other components constituting the robotic and the structural part 12 and is fixed in position at the holes 127. In some other example embodiments (not shown), the mounting interface may extend lengthwise along the tubular body. A plurality of holes may extend radially and is circumferentially distributed around the mounting opening. Other components constituting the robot, such as another robotic arm or the actuator, may be fixed to the structural part via the lengthwise extending portion. For example, a plurality of screw fasteners can radially connect the other components constituting the robotic and the structural part and is fixed in position at the holes.

The robotic arm body 10 includes the reinforcement part 16. The reinforcement part 16 is fixed to the body portion 122 at the opening 124. The provision of the opening 124 generally decreases the structural strength of the structural part 12. When the robot formed by the robotic arm body 10 operates over time, the robotic arm body 10 may break. With the reinforcement part 16 provided at the opening 124, structural strength of the robotic arm body 10 can be greatly improved.

The cover 14 is located above the reinforcement part 16 and configured to close the inner chamber of the body portion 122. With the cover, the inner part can be prevented from exposing to the user. Typically, the cover 14 may be made of plastic material with lower strength.

In some example embodiments, the reinforcement part 16 may be made of the same plastic material as the structural part 12. In some other example embodiments, the reinforcement part 16 may made of different material from the plastic material for forming the structural part 12. The material for constructing the reinforcement part 16 may be metal, such as aluminum alloy, steel, and the like, and may be plastic material but of higher rigidity than the plastic material for forming the structural part 12.

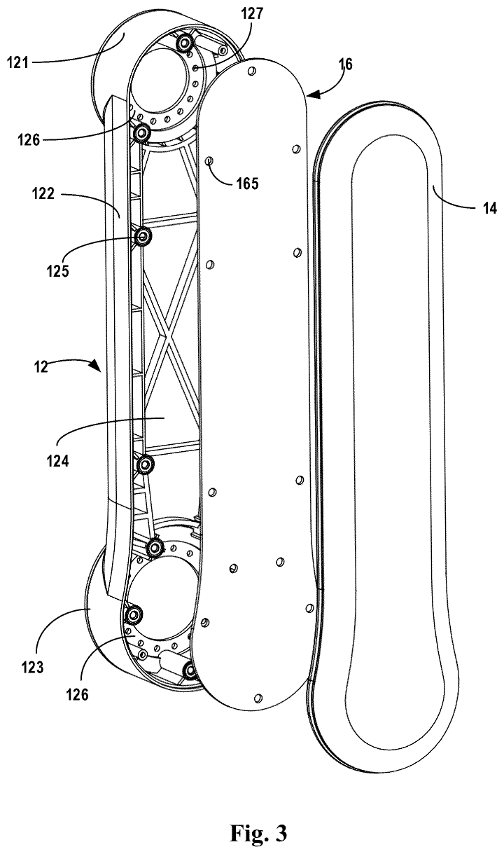

The reinforcement part 16 may be of various shapes. In some embodiments, the reinforcement part 16 may be a metal plate that fits within the opening 124. In some example embodiments, as shown in FIGS. 2 and 3, the reinforcement part 16 is shaped to match a size of the opening 124. When the reinforcement part 16 is arranged within the opening 124, the reinforcement part 16 substantially closes the opening 124. The term “close” herein means that the reinforcement part 16 extends across the opening and the outer circumferential edge of the reinforcement part 16 substantially contacts the inner wall of the structural part 12. With this arrangement, since the circumferential edge of the opening is supported by the reinforcement part 16, the strength of the robotic arm body 10 can be ensured.

In the shown example, the reinforcement part 16 is shown to be one plate form. Alternatively, the reinforcement part 16 may include a plurality of reinforcement members. The member may be arranged as strengthen ribs within the opening. In some other embodiments, some ribs may be configured to bridge opposite sides of the opening.

There are many means for fixing the reinforcement part 16 to the body portion 122 of the structural part 12. The reinforcement part 16 may be fixed to the body portion 122 via screw connection, thermal fusing, snap-fitting, adhesive, and the like. In some embodiments, the body portion 122 of the structural part 12 may include a connection portion configured to engage a corresponding portion in the reinforcement part 16. The connection portion may be various forms, such as one or more steps, one or more flanges, and the like which defines the attaching surface.

In the shown embodiment, as shown in FIG. 3, the reinforcement part 16 may be detachably fixed to the body portion 122 via screw connection. The body portion 122 may include a plurality of connecting posts 125 which are distributed around the opening 124 within the inner chamber. The connecting posts 125 may be of thick material to ensure its strength. The number of the connecting posts 125 and its positions may be designed according to the shape of the reinforcement part 16. The reinforcement part 16 may include a plurality of mounting holes 165 corresponding to the connecting posts 125. The reinforcement part 16 is fixed to the connecting posts 125 by a plurality of screw fasteners 19.

In addition to the connecting posts 125, connection portion on the body portion 122 for connecting to the reinforcement part 16 may be other forms. For example, in some embodiments (not shown), a flange protrudes toward the inner chamber around the opening. Thus, the flange can be used as attaching surface. The following features regarding to the connecting posts 125 may also be applicable to the flange.

In order to further improve strength at the connection interface between the connecting posts 125 and the screw fastener, the connecting post 125 may be made of metal. The connection post 125 may be integrally formed with the structural part 12 via insert molding. The connection post 125 extends in parallel to the tubular body of the end portions 121, 122. This is advantageous for a draft angle. In some other embodiments, the connecting post 125 comprises a plastic connection post and a metal insert is provided within the plastic connecting post 125. In this way, connection between the screw fastener and the connection post 125 is established via metal to metal. This can avoid a creep risk of the plastic material since the screw fastener connecting the plaster material will become loose when operates under pressure over a long time.

In some embodiment, a sealing member may be arranged between the reinforcement part 16 and the structural part 12. When the reinforcement part 16 and the structural part 12 are connected by screw fasteners, the sealing member can be sandwiched between the reinforcement part 16 and the structural part 12 and is fixed in position by the pressure. This is advantageous for applications which require high sealing performances.

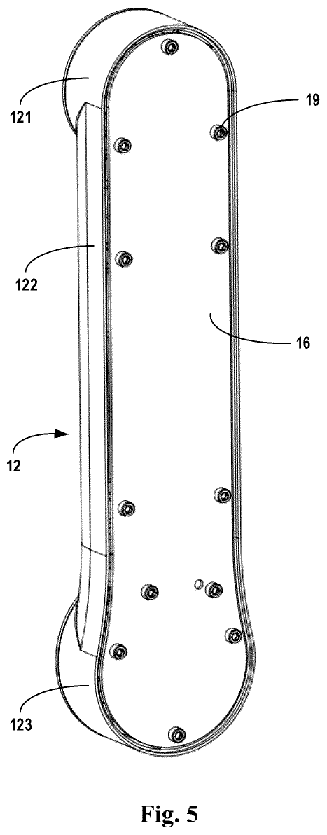

FIG. 5 is a perspective view of a robotic arm body 10 according to a second example embodiment of the present disclosure. The robotic arm body shown in FIG. 5 is analogous to that shown in FIGS. 2-4 and main differences are focused on. As shown in FIG. 5, the robotic arm body 10 may not include the cover. A size of the reinforcement part 16 matches the size of the opening of the structural part 12. The reinforcement part 16 may include a plurality of through holes and is fixed to the structural part 12 via a plurality of screw fasteners 19. When the reinforcement part 16 is fixed in position, an outer surface of the reinforcement part 16 may be directly exposed to the user. There is no need of provision of the cover.

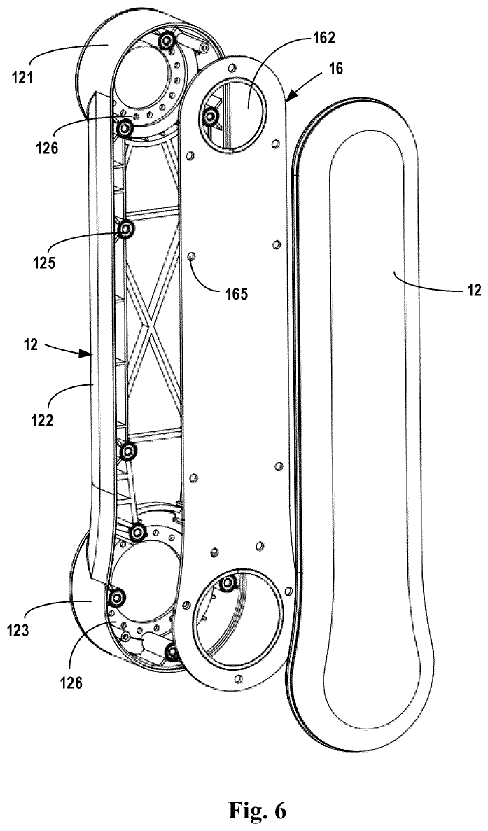

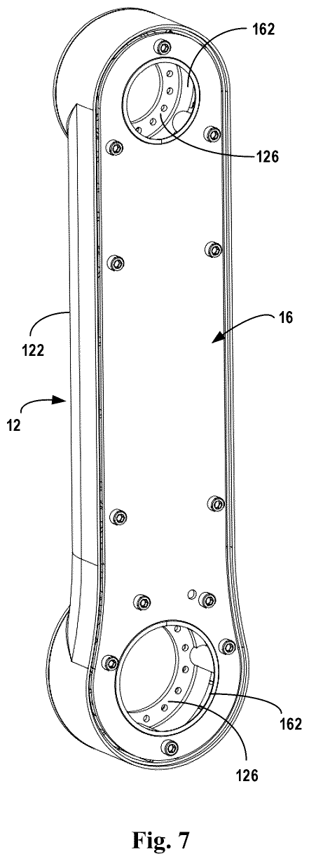

FIGS. 6 and 7 show a robotic arm body 10 according to a third example embodiment of the present disclosure. The robotic arm body shown in FIGS. 6 and 7 is analogous to that shown in FIGS. 2-4 and main differences are focused on. As shown in FIGS. 6 and 7, the reinforcement part 16 may include a manhole 162 at a position corresponding to the mounting interface 126. Through the manhole 162, the engineer can easily access the inner chamber of the structural part 12 without detaching the reinforcement part 16 from the structural part 12. With this arrangement, once the reinforcement part 16 is assembled in position, there is no need to detach the reinforcement part 16 from the structural part 12 any longer. This is advantageous when the reinforcement part 16 is fixed to the structural part 12 in an undetached manner, for example, adhesive and thermal fusion.

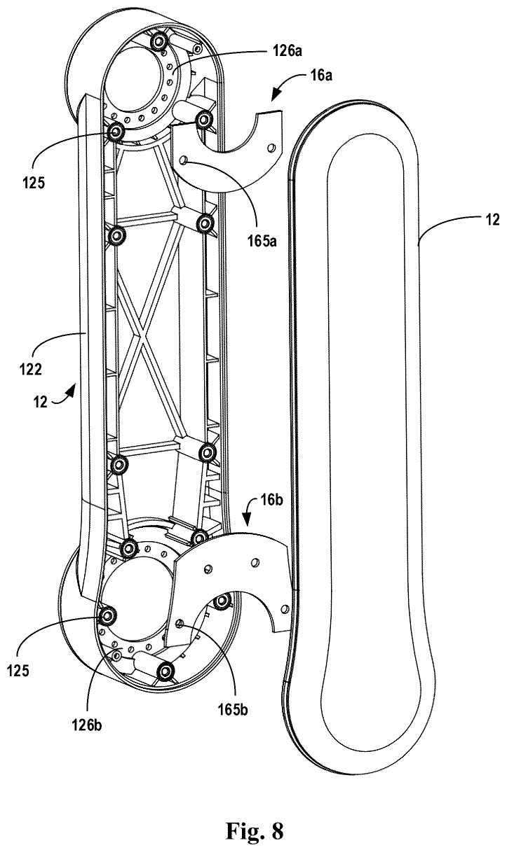

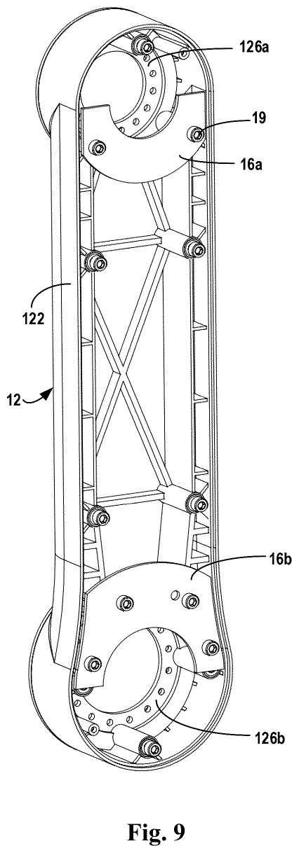

FIGS. 8 and 9 show a robotic arm body 10 according to a fourth example embodiment of the present disclosure. The robotic arm body 10 shown in FIGS. 8 and 9 is analogous to that shown in FIGS. 2-4 and main differences are focused on.

As shown in FIGS. 8 and 9, the robotic arm body 10 may include two reinforcement parts 16a, 16b within the inner chamber. The two reinforcement parts 16a, 16b are configured to partially strengthen the structural part 12. The strength of the structural part 12 may be insufficient at some positions, for example, a root portion of robotic arm body 10, a connection portion of the robotic arm body 10 (for example, the mounting interface 126). The reinforcement parts 16a, 16b may be arranged at these positions to strengthen the structural part. In the shown example, the mounting interface 126 includes a plurality of screw holes for connection, and the reinforcement parts 16a, 16b may be arranged within the inner chamber adjacent to the mounting interface 126. With this arrangement, the strength at the mounting interface 126 can be improved. The reinforcement parts 16a, 16b may be of various shapes. In the shown example, the reinforcement parts 16a, 16b is a semi-annular shaped. The structural part 12 can be strengthened with less material. Thus, the weight of the structural part 12 can be further reduced. The reinforcement part 16a, 16b may be fixed to the body portion 122 via screw connection, thermal fusing, snap-fitting, adhesive, and the like.

In some example embodiments (not shown), the reinforcement part may include a plurality of reinforcement parts. The reinforcement parts may include a first reinforcement part shaped to match a size of the opening 124 to close the opening 124. The reinforcement parts may further include a partial reinforcement part which may be provided within the inner chamber adjacent to the at least one mounting interface 126. This may be advantageous for heavy load applications.

In some embodiments, the partial reinforcement part can be sandwiched between the first reinforcement part and the structural part 12. The partial reinforcement part may include a plural of through holes. A screw fastener can sequentially passes a through hole in the first reinforcement part, a through hole in the partial reinforcement part, and then engages a screw hole provided in the connecting posts 125. In this way, the connecting posts 125 provided in the body portion 122 may be shared by the partial reinforcement part and the first reinforcement part.

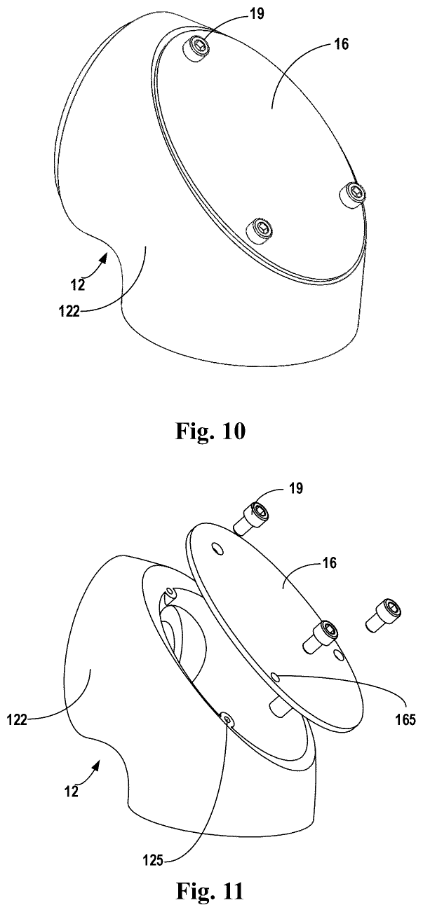

FIGS. 10 and 11 show a robotic arm body 10 according to a fifth example embodiment of the present disclosure. The robotic arm body shown in FIGS. 10 and 11 is analogous to that shown in FIGS. 2-4 and main differences are focused on. As shown in FIGS. 10 and 11, the robotic arm body 10 is in a pipe form which curved in an L-shape. Two opposite end portions of the pipe may be used as the mounting interface (not shown) for connecting to other components constituting the robot. The robotic arm body 10 shown in FIGS. 10 and 11 may be used as a casing of a joint. Within an inner chamber of the robotic arm body 10, an actuator may be arranged. An opening 124 is provided at a bent portion of the pipe and may be used as operating opening. The existence of the opening 124 may facilitate access to the inner side of pipe but greatly decrease the strength of the pipe.

The reinforcement part 16 is fixed to the body portion 122 at the opening 124. The reinforcement part 16 may be of various shapes. In some embodiments, the reinforcement part 16 may be a metal plate that fits within the opening 124. In some example embodiments, the reinforcement part 16 is shaped to match a size of the opening 124. When the reinforcement part 16 is arranged within the opening 124, the reinforcement part 16 substantially closes the opening 124. With this arrangement, the strength of the robotic arm body 10 can be ensured.

In the shown example, the body portion 122 may include a plurality of connecting posts 125. The reinforcement part 16 may include a plurality of mounting holes 165 corresponding to the connecting posts 125. The reinforcement part 16 is fixed to the connecting posts 125 by a plurality of screw fasteners 19. It is to be understood that the shown example is merely illustrative and the reinforcement part 16 may be fixed to the body portion 122 via other means, for example, thermal fusing, snap-fitting, adhesive, and the like.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. A robotic arm body comprising:
a structural part comprising:
a body portion made of plastic material and comprising an inner chamber;
at least one mounting interface provided on the body portion and configured to be connected to a second component of a robot;
an opening provided in the body portion and communicating with the inner chamber; and
a reinforcement part fixed to the body portion at the opening.

2. The robotic arm body according to claim 1, wherein the reinforcement part is shaped to match the opening to close the opening.

3. The robotic arm body according to claim 1, wherein the reinforcement part is fixed to the body portion via at least one of the following: screw connection, thermal fusing, snap-fitting, and adhesive.

4. The robotic arm body according to claim 1, wherein:
the body portion comprises a flange protruding toward the inner chamber around the opening or a plurality of connecting posts distributed around the opening within the inner chamber;
the reinforcement part comprises a plurality of mounting holes for screw connection; and
the reinforcement part is fixed to the flange or the plurality of connecting posts by a plurality of screw fasteners.

5. The robotic arm body according to claim 4, wherein the flange or the plurality of connecting posts comprise a metal connection portion, or a plastic connection portion in which a metal insert is provided.

6. The robotic arm body according to claim 1, wherein the structural part is a one-piece part which is integrally formed via injection molding.

7. The robotic arm body according to claim 1, wherein the reinforcement part is made of the same material as the structural part or of a second material having rigidity greater than the structural part.

8. The robotic arm body according to claim 1, wherein the reinforcement part is a metal plate.

9. The robotic arm body according to claim 1, wherein the reinforcement part comprises a manhole at a position corresponding to the mounting interface.

10. The robotic arm body according to claim 1, further comprising a cover above the reinforcement part and configured to close the opening.

11. The robotic arm body according to claim 1, wherein the reinforcement part comprises at least one reinforcement part provided within the inner chamber adjacent to the at least one mounting interface.

12. The robotic arm body according to claim 1, wherein the reinforcement part comprises:
a first reinforcement part shaped to match a size of the opening to close the opening; and
at least one second reinforcement part arranged between the first reinforcement part and the body portion the second reinforcement part provided within the inner chamber adjacent to the at least one mounting interface.

13. The robotic arm body according to claim 12, wherein at least one of the first reinforcement part and the second reinforcement part is fixed to the body portion via at least one of the following: screw connection, thermal fusing, snap-fitting, or adhesive.

14. The robotic arm body according to claim 1, wherein the body portion is an elongate arm form and comprises:
an elongate body comprising a first lengthwise side and a second lengthwise side opposite to the first lengthwise side; and
two opposite end portions located a respective end of the an elongate body, each of the end portions comprising a tubular body; and
wherein the mounting interface is provided on the tubular body at the first lengthwise side and the opening is provided at the second lengthwise side.

15. The robotic arm body according to claim 1, wherein the body portion is in a pipe form curved in an L-shape and comprising two opposite end portions, the mounting interface is provided at one of the end portion, and the opening is provided at a bent portion of the pipe.

16. An industrial robot comprising:
a base, and
a the robotic arm body according to claim 1.
